(19) United States
(12) Patent Application Publication
(10) Pub. No.: US 2026/0001126 A1
(43) Pub. Date: Jan. 1, 2026

(54) SINTERED CERIUM-IRON-BORON AND PREPARATION METHOD THEREOF

(71) Applicant: NINGBO JINLUN MAGNET TECHNOLOGY CO., LTD., Ningbo (CN)

(72) Inventor: Yongxin LIANG, Ningbo (CN)

(21) Appl. No.: 19/250,262

(22) Filed: Jun. 26, 2025

Related U.S. Application Data
(63) Continuation of application No. PCT/CN2025/099187, filed on Jun. 5, 2025.

(30) Foreign Application Priority Data
Jun. 28, 2024 (CN) 202410857853.0

(51) Int. Cl. B22F 3/16; B22F 3/24; B22F 9/04; C22C 1/02; C22C 33/04

(52) U.S. Cl. CPC B22F 3/16; B22F 3/24; B22F 9/04; C22C 1/02; C22C 33/04; B22F 2003/242; B22F 2003/247; B22F 2003/248; B22F 2009/043; B22F 2201/10; B22F 2201/20; B22F 2301/10; B22F 2301/355

(57) ABSTRACT

A sintered cerium-iron-boron and a preparation method thereof. The preparation method includes the following steps: melting and blending all raw materials, cooling, crushing, powder milling, magnetically forming, isostatic pressing, sintering, solution treating, first stage aging, and second stage aging to obtain a product; melting and blending a first phase alloy and a second phase alloy to obtain a diffusion source; and then subjecting the product to a diffusion treatment with two diffusion stages using the diffusion source to obtain the cerium-iron-boron.

### CROSS-REFERENCE TO RELATED APPLICATION

The present application is a continuation of PCT application serial No. PCT/CN2025/099187, filed on Jun. 5, 2025, which claims the priority benefits of China patent application No. 202410857853.0, filed on Jun. 28, 2024. The entireties of PCT application serial No. PCT/CN2025/099187 and China patent application No. 202410857853.0 are hereby incorporated by reference herein and made a part of this specification.

### TECHNICAL FIELD

The present application relates to a technical field of magnetic materials, and, in particular, to a sintered cerium-iron-boron and a preparation method thereof.

### BACKGROUND ART

Since the invention, the rare-earth permanent magnet materials have always been favored by numerous industries due to excellent properties. Among various rare-earth permanent magnet materials, samarium-cobalt magnets and neodymium-iron-boron magnets are the two most widely used. Samarium-cobalt magnets have very high magnetic properties and good high-temperature resistance. However, samarium and cobalt in raw materials are relatively rare and expensive, which limit the further widespread application of the samarium-cobalt magnets. On the other hand, neodymium-iron-boron magnets possess equally excellent magnetic properties and are currently the permanent magnets with the highest magnetic performance. Moreover, compared with samarium-cobalt magnets, neodymium-iron-boron magnets have a lower cost, thus having higher application value.

However, in practical use, it has been found that neodymium-iron-boron magnets suffer a significant reduction in magnetic performance when used in high-temperature environments. Therefore, technicians have proposed partially replacing neodymium (Nd) with other rare-earth elements to improve the high-temperature resistance of neodymium-iron-boron. Additionally, with the growing demand for neodymium-iron-boron, the supply of neodymium has become insufficient, leading people to turn their attention to another rare-earth element-cerium (Ce). By incorporating Ce into neodymium-iron-boron at a certain ratio, a new type of permanent magnet material, cerium-iron-boron, can be obtained. Based on the chemical properties of Ce and Nd, cerium-iron-boron not only exhibits good magnetic performance but also has more excellent mechanical properties, higher high-temperature resistance, and more stable and lower cost compared to neodymium-iron-boron.

However, during the preparation of cerium-iron-boron, the diffusion of Ce on the surface of the magnet will form coarse grains, which reduce the intrinsic coercivity of cerium-iron-boron and limit its application in fields that require high magnetic performance requirements, such as wireless charging, relays, and sensors.

### SUMMARY

In order to solve the above technical problems, the present application provides a sintered cerium-iron-boron and a preparation thereof.

In a first aspect, a method for preparing a sintered cerium-iron-boron provided in the present application includes the following steps: melting and blending all raw materials, cooling to obtain an alloy ingot with an expression (Nd,M)ₐCe₂₋ₐFe₁₄B, and then subjecting the alloy ingot to crushing, powder milling, magnetically forming, isostatic pressing, sintering, solution treating, first stage aging, and second stage aging to obtain a product, wherein a=1.06-1.38, Mis at least one selected from a group consisting of: Gd, Ti, and Zr; melting and blending a first phase alloy and a second phase alloy with a weight ratio of 1:(0.8-1.0) at a vacuum degree of −0.1 MPa˜0.02 MPa and a temperature of 1300-1350° C., cooling, and obtaining a diffusion source after a post-treatment; an expression of the first phase alloy is PrₓCu₁₀₀₋ₓ, wherein x=68-72, and an expression of the second phase alloy is Pr_{y}Tb₁₀Cu_{90-y}, wherein y=58-62; then, coating the diffusion source on a surface of the product, performing a first diffusion for 1.5-2 hours under a vacuum degree of 4.8×10⁻³-5.2×10⁻³ Pa and a temperature of 850-900° C., and performing a second diffusion for 3-6 hours at a temperature of 980-1080° C., then cooling a resulting system to a temperature of 480-500° C., annealing for 1.5-2.5 hours, and finally cooling to room temperature to obtain the cerium-iron-boron.

By adopting the above technical solution, the present application prepares the diffusion source by melting the first phase alloy and the second phase alloy, and then uniformly coats the diffusion source on the outer surface of a cerium-iron-boron green body. At certain diffusion temperature and diffusion time, the diffusion source can exhibit a grain boundary diffusion effect. Pr and Tb will be enriched on the surface of the cerium-iron-boron green body and form a Pr-rich shell layer and a Tb-rich shell layer, generating a continuous grain boundary phase, which improves the magnetocrystalline anisotropy field strength of the cerium-iron-boron surface, and can suppress the magnetization reversal of the main phase grains in the cerium-iron-boron, thereby greatly improving the intrinsic coercivity and remanence of the cerium-iron-boron. Moreover, the synergistic effect between Pr and Tb can be fully exerted, further enhancing the magnetocrystalline anisotropy field strength of the cerium-iron-boron surface. The enrichment of Tb on the surface of the magnet can compensate for the negative impact of coarse grains on magnetic properties, further compensating for the deficiency of magnetic properties; Cu can compensate for the loss of mechanical strength of the cerium-iron-boron after adding Pr and Tb. Therefore, the diffusion heat treatment of the cerium-iron-boron green body in the present application can effectively improve the magnetic properties of the cerium-iron-boron, while almost not affecting the mechanical strength of the cerium-iron-boron.

Moreover, the present application adopts a two-step diffusion method in the diffusion heat treatment. At a temperature of 850-900° C., rapid grain boundary diffusion mainly occurs inside the cerium-iron-boron, greatly optimizing the magnetic properties of the cerium-iron-boron. Subsequently, the present application raises the temperature to 980-1080° C. and performs the second diffusion, resulting in more significant bulk diffusion inside the cerium-iron-boron. The movement of atoms or ions inside the grains gradually becomes more uniform, and uniformly arranged atoms or ions can further enhance the magnetic properties of the cerium-iron-boron.

Preferably, the post-treatment specifically includes: cutting a cooled mixture to obtain sheet-shaped diffusion sources.

By adopting the above technical solution, the present application cuts the diffusion source into sheets and uses the sheet-shaped diffusion source for treatment. Compared with powder diffusion source treatment or coating diffusion treatment, the grain boundary diffusion of the sheet-shaped diffusion sources is more significant in the two-dimensional direction, with a larger ratio of diffusion surface area to volume. The interaction between the surface and grain boundary interface of the cerium-iron-boron is more significant, which can further enhance the magnetocrystalline anisotropy field strength of the cerium-iron-boron surface. Moreover, although powder materials have more diffusion paths and coating diffusion has a faster diffusion rate, there is already Ce in the cerium-iron-boron that can promote diffusion. If the coating diffusion source or the powder diffusion source is used, excessive diffusion will occur, resulting in a decrease in chemical uniformity between alloy particles and a reduction in mechanical strength of the cerium-iron-boron. Therefore, the present application uses a sheet-shaped diffusion source in the grain boundary diffusion of the cerium-iron-boron, which can achieve both the effects of improving mechanical properties and ensuring good diffusion.

Preferably, a time of the first diffusion is 1.8 hours, and a time of the second diffusion is 4 hours.

By adopting the above technical solution, the present application further enhances the magnetic properties of the cerium-iron-boron by controlling the time of the first diffusion and the second diffusion.

Preferably, in the expression of the alloy ingot, a=1.25-1.35.

By adopting the above technical solution, the present application further optimizes the overall performance of the cerium-iron-boron by controlling the amount of Ce added. Due to Ce can promote the enrichment of Pr and Tb on the surface of the cerium-iron-boron to a certain extent, Ce plays an auxiliary role in enhancing the magnetic properties during diffusion heat treatment. Experimental data has shown that when a=1.25-1.35, the cerium-iron-boron has good high-temperature resistance and low cost, which can effectively assist in enhancing the magnetic properties during diffusion heat treatment. At the same time, the number of coarse grains is small, which can effectively optimize the magnetic properties, resulting in high remanence and intrinsic coercivity.

Preferably, after melting and blending all raw materials, cooling is performed at a rate of 40-80° C./s to obtain the alloy ingot.

Compared with Nd, Ce has more active chemical properties and is prone to oxidation reactions. By adopting the above technical solution, the present application controls the cooling rate, which is much higher than the natural cooling rate (average 2° C./min). Rapid cooling can greatly shorten the time that Ce in the alloy ingot comes into contact with oxygen during the cooling process, thereby reducing the possibility of Ce oxidation and reducing the number of magnetic phases oxidized and decomposed in the cerium-iron-boron, ensuring that the intrinsic coercivity of the cerium-iron-boron is almost unaffected.

Preferably, the sintering is performed in two stages, specifically: holding a material obtained after isostatic pressing at a temperature of 800-850° C. for 1-1.5 hours, then heating the temperature up to 1050-1100° C. and holding for 2-2.5 hours, followed by solution treating.

By adopting the above technical solution, the present application performs sintering in two stages, which can fully discharge the organic matter, gas adsorbed on the particle surface, and gas remaining in the pores of the cerium-iron-boron blank, improving the purity of the cerium-iron-boron blank and thereby optimizing the mechanical properties of the cerium-iron-boron blank. Additionally, the two-stage sintering process can further control the growth of grains to produce more uniform and smaller grains, significantly reducing the number and growth rate of coarse grains, thereby enhancing the remanence and intrinsic coercivity of the cerium-iron-boron.

Preferably, a time of the first stage aging is 3-4 hours.

Preferably, a time of the second stage aging is 22-23 hours.

By adopting the above technical solution, the present application controls the time for the first stage aging and the time for the second stage aging. Within the time range, the number of intact cells inside the cerium-iron-boron is relatively large, and the regularity of the internal cell structure and the continuity of the cell wall phase are also high. At the same time, the possibility of large cells swallowing small cells occurring inside the cerium-iron-boron blank is low, and the cell structure has a strong pinning effect on the domain wall. The enhancement of pinning effect will simultaneously improve the magnetic properties, high-temperature resistance, and mechanical properties of the cerium-iron-boron.

In a second aspect, the present application provides a cerium-iron-boron prepared by the above preparation method, which has good magnetic and mechanical properties, with a remanence of over 1.35 T, an intrinsic coercivity of over 890 kA·m−1, and a bending strength of over 849 MPa at 25° C.

In summary, the present application includes the following beneficial technical effects.
1. In the preparation method of the present application, diffusion heat treatment was performed on the cerium-iron-boron green body, which can effectively improve the magnetic properties of the cerium-iron-boron, while almost not affecting the mechanical strength of the cerium-iron-boron;
2. The preparation method of cerium-iron-boron in the present application uses the sheet-shaped diffusion source in grain boundary diffusion, which can simultaneously enhance the mechanical properties and ensure good diffusion;
3. The preparation method of the cerium-iron-boron in the present application strictly controls the processing conditions of sintering, aging, and diffusion heat treatment, which significantly improves the magnetic properties, high-temperature resistance, and mechanical properties of the cerium-iron-boron.

### DETAILED DESCRIPTION

### Materials Source

Unless otherwise specified, the raw materials used in the present application are all commercially available products, specifically:
Nd was purchased from Jiangxi Ruida Rare Earth Co., Ltd. with a purity of 98.5%;
Ce was purchased from Baotou Jingxin Rare Earth New Materials Co., Ltd., with a rare earth content of over 99%;
Fe was purchased from Henan Yuanheng Powder Metallurgy Co., Ltd. with a purity of over 99%;
B was purchased from Nangong Xindun Alloy Welding Material Spray Co., Ltd. with a purity of 99%;
Cu was purchased from Bo Huasi Nano Technology (Ningbo) Co., Ltd. with a purity of 99.95%;
Gd was purchased from Yipin Chuancheng (Beijing) Technology Co., Ltd. with a purity of 99.99%;
Ti was purchased from Dongguan Maoteng Metal Materials Co., Ltd. with a purity of 99.9%;
Zr was purchased from Beijing Xingrongyuan Technology Co., Ltd. with a purity of 99%;
Pr was purchased from Suzhou Kangyang Automation Co., Ltd. with a purity of 99.9%;
Tb was purchased from Hengshui Yiye Metal Materials Trading Co., Ltd. with a purity of 99.9%;
Dy was purchased from Hebei Jiuyue New Material Technology Co., Ltd. with a purity of 99.9%;
   The activator was purchased from Guangzhou Yishun Chemical Co., Ltd., with an effective substance content of 99.9wt %.

The present application will be further described in detail below, with reference to the Examples and Comparative Examples.

### Example 1.1

A method for preparing a sintered cerium-iron-boron, including the following steps:
S11: Melting: Nd, Gd, Ti, Ce, Fe, and B were placed in a system with a vacuum degree of −0.1 MPa, then melted and blended at a temperature of 1500° C. to obtain a mixture; and the mixture was naturally cooled (2° C./min) to room temperature to obtain an alloy ingot with an expression of (Nd, Gd, Ti) _{1.06}Ce_{0.94}Fe₁₄B;
S12: Crushing and powder milling: the alloy ingot obtained in step S11 was first crushed to a particle size of less than 10 mm, and then secondary crushed to a particle size of less than 1 mm; a coarse powder obtained after secondary crushing was then ball milled under the protection of an inert gas to obtain an alloy powder with a particle size of 4±0.5 μm;
S13: Magnetically forming and isostatic pressing: under the protection of inert gas, the alloy powder obtained in step S12 was oriented and formed in an open press with a magnetic field, with a magnetic field strength of 2 T to obtain an oriented and formed cerium-iron-boron powder; the oriented and formed cerium-iron-boron powder was then subjected to cold isostatic pressing at a pressure of 220 MPa for 35 minutes to obtain a cerium-iron-boron green body;
S14: Sintering and solution treating: the cerium-iron-boron green body obtained in step S13 was placed in a vacuum system at a vacuum degree of 4×10⁻³ Pa; and a temperature was raised to 800° C. and held for 4 hours for sintering, then raised to 900° C. and held for 4 hours for solution treating to obtain a cerium-iron-boron blank;
S15: Aging: the cerium-iron-boron blank obtained in step S14 was subjected to a first stage aging at 800° C. for 2 hours under the protection of inert gas; then the temperature was cooled down at a rate of 0.8° C./min to 500° C., followed by a second stage aging for 24 hours; and then the temperature was air-cooled to room temperature to obtain a product;
S21: Preparation of diffusion source: 1 kg of a first phase alloy Pr₆₈Cu₃₄ and 1 kg of a second phase alloy Pr₅₈Tb₁₀Cu₃₂ were melted and blended under a vacuum degree of 0.02 MPa at 1350° C., and a resulting mixture was cooled, and then ball milled under the protection of inert gas to obtain a powder diffusion source with a particle size of 2±0.5 μm; and
S22: Diffusion heat treatment: the product obtained in S15 was cut to obtain cerium-iron-boron thin sheets with a thickness of 1±0.05 cm, an oxide scale on a surface of the thin sheets was removed by grinding with 400-mesh metallographic sandpaper, and then thin sheets were completely immersed in an activator water solution with a concentration of 25wt % at 35° C., and cleaned in an ultrasonic cleaner for 3 minutes to remove other impurities on the surface and obtain a de-impurity cerium-iron-boron; each surface of the de-impurity cerium-iron-boron was coated with the powder diffusion source obtained in step S21, and then a first diffusion was performed under a vacuum degree of 5.2×10⁻³ Pa and a diffusion temperature of 900° C. for 1.5 hours, followed by a second diffusion at 1080° C. for 3 hours, then a resulting system was cooled to 480° C., annealed for 2.5 hours, and finally cooled to room temperature to obtain the cerium-iron-boron.

### Example 1.2

A method for preparing a sintered cerium-iron-boron, including the following steps:
S11: Melting: Nd, Ti, Zr, Ce, Fe and B were placed in a system with a vacuum degree of −0.1 MPa, then melted and blended at a temperature of 1500° C. to obtain a mixture; and the mixture was naturally cooled to room temperature to obtain an alloy ingot with an expression of (Nd,Ti,Zr)_{1.38}Ce_{0.62}Fe₁₄B;
S12: Crushing and powder milling: the alloy ingot obtained in step S11 was first crushed to a particle size of less than 10 mm, and then secondary crushed to a particle size of less than 1 mm; a coarse powder obtained after secondary crushing was then ball milled under the protection of an inert gas to obtain an alloy powder with a particle size of 4±0.5 μm;
S13: Magnetically forming and isostatic pressing: under the protection of inert gas, the alloy powder obtained in step S12 was oriented and formed in an open press with a magnetic field, with a magnetic field strength of 2 T to obtain an oriented and formed cerium-iron-boron powder; the oriented and formed cerium-iron-boron powder was then subjected to cold isostatic pressing at a pressure of 220 MPa for 35 minutes to obtain a cerium-iron-boron green body;
S14: Sintering and solution treating: the cerium-iron-boron green body obtained in step S13 was placed in a vacuum system at a vacuum degree of 4×10⁻³ Pa; and a temperature was raised to 1100° C. and held for 3 hours for sintering, then reduced to 850° C. and held for 4 hours for solution treating to obtain a cerium-iron-boron blank;
S15: Aging: the cerium-iron-boron blank obtained in step S14 was subjected to a first stage aging at 800° C. for 2 hours under the protection of inert gas; then the temperature was cooled down at a rate of 0.8° C./min to 500° C., followed by a second stage aging for 24 hours; and then the temperature was air-cooled to room temperature to obtain a product;
S21: Preparation of diffusion source: 1 kg of a first phase alloy Pr₇₂Cu₂₈ and 1 kg of a second phase alloy Pr₆₂Tb₁₀Cu₂₈ were melted and blended under a vacuum degree of −0.1 MPa at 1300° C., and a resulting mixture was cooled, and then ball milled under the protection of inert gas to obtain a powder diffusion source with a particle size of 2±0.5 μm; and
S22: Diffusion heat treatment: the product obtained in S15 was cut to obtain cerium-iron-boron thin sheets with a thickness of 1±0.05 cm, an oxide scale on a surface of the thin sheets was removed by grinding with 400-mesh metallographic sandpaper, and then thin sheets were completely immersed in an activator water solution with a concentration of 25wt % at 35° C., and cleaned in an ultrasonic cleaner for 3 minutes to remove other impurities on the surface and obtain a de-impurity cerium-iron-boron; each surface of the de-impurity cerium-iron-boron was coated with the powder diffusion source obtained in step S21, and then a first diffusion was performed under a vacuum degree of 4.8×10⁻³ Pa and a diffusion temperature of 850° C. for 2 hours, followed by a second diffusion at 980° C. for 6 hours, then a resulting system was cooled to 500° C., annealed for 2 hours, and finally cooled to room temperature to obtain the cerium-iron-boron.

### Example 1.3-1.7

A method for preparing a sintered cerium-iron-boron, the difference between Example 1.3-1.7 and Example 1.1 is that: the type of M and the value of a in Step S11 were changed to obtain alloy ingots with different expressions (see Table 1), and the rest steps were the same as Example 1.1.

TABLE 1

| Example | Raw materials used | Expression |
|---|---|---|
| 1.3 | Nd, Gd, Zr, Ce, Fe, B | (Nd, Gd, Zr)_{1.06}Ce_{0.94}Fe₁₄B |
| 1.4 | Nd, Gd, Ce, Fe, B | (Nd, Gd)_{1.16}Ce_{0.84}Fe₁₄B |
| 1.5 | Nd, Zr, Ce, Fe, B | (Nd, Zr)_{1.26}Ce_{0.74}Fe₁₄B |
| 1.6 | Nd, Ti, Ce, Fe, B | (Nd, Ti)_{1.30}Ce_{0.7}Fe₁₄B |
| 1.7 | Nd, Gd, Zr, Ti, Ce, Fe, B | (Nd, Gd, Zr, Ti)_{1.35}Ce_{0.65}Fe₁₄B |

### Example 1.8

A method for preparing a sintered cerium-iron-boron, the difference between Example 1.8 and Example 1.1 is that: in Step S11, a=1.25, and an alloy ingot with an expression of (Nd, Gd, Ti) _{1.25}Ce_{0.75}Fe₁₄B was obtained, and the rest steps were the same as Example 1.1.

### Example 1.9

A method for preparing a sintered cerium-iron-boron, the difference between Example 1.9 and Example 1.1 is that: in Step S11, a=1.35, and an alloy ingot with an expression of (Nd, Gd, Ti) _{1.35}Ce_{0.65}Fe₁₄B was obtained, and the rest steps were the same as Example 1.1.

### Example 2.1

A method for preparing a sintered cerium-iron-boron, the difference between Example 2.1 and Example 1.1 is that: in step S11, the mixture was cooled to room temperature at a rate of 40° C./s, and the rest steps were the same as Example 1.1.

### Example 2.2

A method for preparing a sintered cerium-iron-boron, the difference between Example 2.2 and Example 1.1 is that: in step S11, the mixture was cooled to room temperature at a rate of 80° C./s, and the rest steps were the same as Example 1.1.

### Example 3.1

A method for preparing a sintered cerium-iron-boron, the difference between Example 3.1 and Example 1.1 is that: in step S2, a sheet-shaped diffusion source was used for diffusion heat treatment, specifically:
S21: Preparation of diffusion source: 1 kg of a first phase alloy Pr₆₈Cu₃₄ and 1 kg of a second phase alloy Pr₅₈Tb₁₀Cu₃₂ were melted and blended under a vacuum degree of 0.02 MPa at 1350° C., and a resulting mixture was cooled, and then cut to obtain sheet-shaped diffusion sources with a thickness of 0.6±0.05 mm; and
S22: Diffusion heat treatment: cutting the product obtained in S15 was cut to obtain cerium-iron-boron thin sheets with a thickness of 1±0.05 cm, an oxide scale on a surface of the thin sheets was removed by grinding with 400-mesh metallographic sandpaper, and then thin sheets were completely immersed in an activator water solution with a concentration of 25wt % at 35° C., and cleaned in an ultrasonic cleaner for 3 minutes to remove other impurities on the surface and obtain a de-impurity cerium-iron-boron; each surface of the de-impurity cerium-iron-boron was coated with the sheet-shaped diffusion sources obtained in step S21, and then a diffusion was performed under a vacuum degree of 5.2×10⁻³ Pa and a diffusion temperature of 850° C. for 8 hours, then a resulting system was cooled to 480° C., annealed for 2.5 hours, and finally cooled to room temperature to obtain the cerium-iron-boron.

### Example 3.2

A method for preparing a sintered cerium-iron-boron, the difference between Example 3.2 and Example 1.1 is that: in step S2, a diffusion source coating was used for diffusion heat treatment, specifically:
S21: Preparation of diffusion source: 1 kg of a first phase alloy Pr₆₈Cu₃₄ and 1 kg of a second phase alloy Pr₅₈Tb₁₀Cu₃₂ were melted and blended under a vacuum degree of 0.02 MPa at 1350° C., and a resulting mixture was cooled, and then dissolved in ethanol to obtain a mixed liquid diffusion source; and
S22: Diffusion heat treatment: the product obtained in S15 was cut to obtain cerium-iron-boron thin sheets with a thickness of 1±0.05 cm, an oxide scale on a surface of the thin sheets was removed by grinding with 400-mesh metallographic sandpaper, and then thin sheets were completely immersed in an activator water solution with a concentration of 25wt % at 35° C., and cleaned in an ultrasonic cleaner for 3 minutes to remove other impurities on the surface and obtain a de-impurity cerium-iron-boron; then the de-impurity cerium-iron-boron was placed into the mixed liquid diffusion source obtained in step S21, and a layer of diffusion source coating was deposited onto the de-impurity cerium-iron-boron by electrophoretic deposition; and then the de-impurity cerium-iron-boron was taken out and subjected to diffusion for 8 hours under a vacuum degree of 5.2×10⁻³ Pa and a diffusion temperature of 850° C., then a resulting system was cooled to 480° C., annealed for 2.5 hours, and finally cooled to room temperature to obtain the cerium-iron-boron.

### Example 4.1

A method for preparing a sintered cerium-iron-boron, the difference between Example 4.1 and Example 1.1 is that: in step S22, a time of the first diffusion was 1.6 hours, and the rest steps were the same as Example 1.1.

### Example 4.2

A method for preparing a sintered cerium-iron-boron, the difference between Example 4.2 and Example 1.1 is that: in step S22, a time of the first diffusion was 1.8 hours, and the rest steps were the same as Example 1.1.

### Example 4.3

A method for preparing a sintered cerium-iron-boron, the difference between Example 4.3 and Example 1.1 is that: in step S22, a time of the first diffusion is 2 hours, and the rest steps were the same as Example 1.1.

### Example 4.4

A method for preparing a sintered cerium-iron-boron, the difference between Example 4.4 and Example 1.1 is that: in step S22, a time of the second diffusion was 4 hours, and the rest steps were the same as Example 1.1.

### Example 4.5

A method for preparing a sintered cerium-iron-boron, the difference between Example 4.5 and Example 1.1 is that: in step S22, a time of the second diffusion was 5 hours, and the rest steps were the same as Example 1.1.

### Example 4.6

A method for preparing a sintered cerium-iron-boron, the difference between Example 4.6 and Example 1.1 is that: in step S22, a time of the second diffusion was 6 hours, and the rest steps were the same as Example 1.1.

### Example 5.1

A method for preparing a sintered cerium-iron-boron, the difference between Example 5.1 and Example 1.1 is that: in step S14, the sintering was performed in two stages, specifically: the cerium-iron-boron green body was held at a temperature of 850° C. for 1 hour, then the temperature was heated up to 1100° C. and held for 2 hours, followed by solution treating.

### Example 5.2

A method for preparing a sintered cerium-iron-boron, the difference between Example 5.2 and Example 1.1 is that: in step S14, the sintering was performed in two stages, specifically: the cerium-iron-boron green body was held at a temperature of 800° C. for 1.5 hours, then the temperature was heated up to 1050° C. and held for 2 hours, followed by solution treating.

### Example 6.1

A method for preparing a sintered cerium-iron-boron, the difference between Example 6.1 and Example 1.1 is that: in step S15, a time of the first stage aging was 3 h, and the rest steps were the same as Example 1.1.

### Example 6.2

A method for preparing a sintered cerium-iron-boron, the difference between Example 6.2 and Example 1.1 is that: in step S15, a time of the first stage aging was 4 h, and the rest steps were the same as Example 1.1.

### Example 6.3

A method for preparing a sintered cerium-iron-boron, the difference between Example 6.3 and Example 1.1 is that: in step S15, a time of the first stage aging was 5 h, and the rest steps were the same as Example 1.1.

### Example 6.4

A method for preparing a sintered cerium-iron-boron, the difference between Example 6.4 and Example 1.1 is that: in step S15, a time of the first stage aging was 1 h, and the rest steps were the same as Example 6.1.

### Example 6.5

A method for preparing a sintered cerium-iron-boron, the difference between Example 6.5 and Example 6.1 is that: in step S15, a time of the second stage aging was 21 h, and the rest steps were the same as Example 6.1.

### Example 6.6

A method for preparing a sintered cerium-iron-boron, the difference between Example 6.6 and Example 6.1 is that: in step S15, a time of the second stage aging was 22 h, and the rest steps were the same as Example 6.1.

### Example 6.7

A method for preparing a sintered cerium-iron-boron, the difference between Example 6.7 and Example 6.1 is that: in step S15, a time of the second stage aging was 23 h, and the rest steps were the same as Example 6.1.

### Example 6.8

A method for preparing a sintered cerium-iron-boron, the difference between Example 6.8 and Example 6.1 is that: in step S15, a time of the second stage aging was 25 h, and the rest steps were the same as Example 6.1.

### Example 6.9

A method for preparing a sintered cerium-iron-boron, the difference between Example 6.9 and Example 6.2 is that: in step S15, a time of the second stage aging was 22 h, and the rest steps were the same as Example 6.2.

### Example 6.10

A method for preparing a sintered cerium-iron-boron, the difference between Example 6.10 and Example 6.2 is that: in step S15, a time of the second stage aging was 23 h, and the rest steps were the same as Example 6.2.

### Comparative Example 1

The difference between Comparative Example 1 and Example 1.1 is that: step S21 and step S22 are omitted, and the rest steps were the same as Example 1.1.

### Comparative Example 2

The difference between Comparative Example 2 and Example 1.1 is that, in step S21: Tb in the second phase alloy was replaced with Dy, and the expression for the second phase alloy was Pr₅₈Dy₁₀Cu₃₂, and the rest steps were the same as Example 1.1.

### Comparative Example 3

The difference between Comparative Example 3 and Example 1.1 is that: in step S21, Pr in both the first phase alloy and the second phase alloy was replaced with Dy. The expression for the first phase alloy was Dy₆₈Cu₃₄, and the expression for the second phase alloy was Dy₅₈ Tb₁₀Cu₃₂, and the rest steps were the same as Example 1.1.

### Comparative Example 4

The difference between Comparative Example 4 and Example 1.1 is that: in step S21, Cu in the second phase alloy is removed, and the expression for the second phase alloy was Pr₅₈Tb₁₀, and the rest steps were the same as Example 1.1.

### Comparative Example 5

The difference between Comparative Example 5 and Example 1.1 is that: in step S11, a=0.8, an alloy ingot with an expression of (Nd, Gd, Ti) _{0.8}Ce_{1.2}Fe₁₄B was obtained, and the rest steps were the same as Example 1.1.

### Comparative Example 6

The difference between Comparative Example 6 and Example 1.1 is that: in step S11, a=1.5, an alloy ingot with an expression of (Nd, Gd, Ti) _{1.5}Ce_{0.5}Fe₁₄B was obtained, and the rest steps were the same as Example 1.1.

### Performance Testing

1. The remanence Br and intrinsic coercivity Hej of the samples at 25° C. were measured by using a permanent magnet material measurement system, and the results were recorded in Table 2.
2. The bending strengths (MPa) of the samples at 25° C. and 300° C. were measured according to the method recorded in the “Test method for physical property of rare earth permanent magnetic materials” (GB/T 31967.2-2015). A continuous bending force was applied to the sample by using a three-point bending method until the sample fractures. The bending strength (MPa) was calculated based on the maximum bending force and recorded the results in Table 2.

TABLE 2

| | | | Bending | Bending | Reduction |
|---|---|---|---|---|---|
| | | | strength at | strength at | rate of |
| | | Hcj/kA · | 25° C./ | 300° C./ | bending |
| Groups | Br/T | m⁻¹ | MPa | MPa | strength/% |
| Example 1.1 | 1.38 | 895 | 850 | 763 | 10.24 |
| Example 1.2 | 1.35 | 890 | 855 | 768 | 10.23 |
| Example 1.3 | 1.39 | 896 | 852 | 765 | 10.25 |
| Example 1.4 | 1.38 | 895 | 852 | 765 | 10.25 |
| Example 1.5 | 1.37 | 894 | 850 | 763 | 10.23 |
| Example 1.6 | 1.37 | 895 | 851 | 764 | 10.25 |
| Example 1.7 | 1.38 | 896 | 850 | 763 | 10.25 |
| Example 1.8 | 1.37 | 894 | 854 | 767 | 10.23 |
| Example 1.9 | 1.38 | 895 | 855 | 767 | 10.29 |
| Example 2.1 | 1.40 | 941 | 851 | 764 | 10.25 |
| Example 2.2 | 1.40 | 940 | 851 | 764 | 10.23 |
| Example 3.1 | 1.37 | 895 | 869 | 780 | 10.24 |
| Example 3.2 | 1.38 | 894 | 851 | 763 | 10.34 |
| Example 4.1 | 1.37 | 897 | 850 | 763 | 10.24 |
| Example 4.2 | 1.55 | 925 | 851 | 764 | 10.24 |
| Example 4.3 | 1.39 | 896 | 850 | 763 | 10.23 |
| Example 4.4 | 1.56 | 931 | 850 | 763 | 10.23 |
| Example 4.5 | 1.39 | 896 | 850 | 763 | 10.23 |
| Example 4.6 | 1.38 | 895 | 850 | 763 | 10.24 |
| Example 5.1 | 1.62 | 943 | 872 | 783 | 10.25 |
| Example 5.2 | 1.61 | 945 | 873 | 784 | 10.23 |
| Example 6.1 | 1.60 | 940 | 870 | 781 | 10.23 |
| Example 6.2 | 1.60 | 941 | 870 | 781 | 10.23 |
| Example 6.3 | 1.38 | 896 | 850 | 763 | 10.24 |
| Example 6.4 | 1.36 | 894 | 850 | 763 | 10.24 |
| Example 6.5 | 1.60 | 940 | 870 | 781 | 10.24 |
| Example 6.6 | 1.63 | 951 | 879 | 789 | 10.23 |
| Example 6.7 | 1.62 | 949 | 881 | 791 | 10.23 |
| Example 6.8 | 1.59 | 939 | 871 | 782 | 10.23 |
| Example 6.9 | 1.63 | 953 | 879 | 789 | 10.23 |
| Example 6.10 | 1.63 | 950 | 881 | 791 | 10.23 |
| Comparative | 1.13 | 668 | 849 | 762 | 10.24 |
| Example 1 | | | | | |
| Comparative | 1.26 | 821 | 851 | 764 | 10.25 |
| Example 2 | | | | | |
| Comparative | 1.21 | 819 | 850 | 763 | 10.23 |
| Example 3 | | | | | |
| Comparative | 1.39 | 899 | 810 | 727 | 20.26 |
| Example 4 | | | | | |
| Comparative | 1.28 | 865 | 851 | 774 | 9.01 |
| Example 5 | | | | | |
| Comparative | 1.41 | 911 | 850 | 742 | 12.67 |
| Example 6 | | | | | |

### Data Analysis:

From Table 2, it can be seen that the bending strength at 25° C. of Examples 1.1-1.9 can reach 850-855 MPa, and the bending strength at 300° C. can reach 763-768 MPa. The reduction rate of bending strength is no more than 10.25%. Additionally, Br can reach 1.35-1.38 T, Hc can reach 890-896kA·m⁻¹. These results demonstrate that in the method for preparing the cerium-iron-boron of the present application, the addition amount of cerium is significantly increased, and the high-temperature resistance of the cerium-iron-boron is improved, resulting in a lower rate of decrease in compressive strength of the cerium-iron-boron used at high temperatures. The diffusion heat treatment of the cerium-iron-boron green body in the present application can effectively enhance the magnetic properties of the cerium-iron-boron without affecting the mechanical strength. Among them, the reduction rate of bending strength, remanence, and intrinsic coercivity of the cerium-iron-boron in Examples 1.8-1.9 are relatively high, demonstrating that strictly controlling the addition amount of Ce in the present application can achieve an optimal balance of high-temperature resistance, remanence, and intrinsic coercivity of the cerium-iron-boron.

The remanence and intrinsic coercivity of Examples 2.1-2.2 are higher than those of Example 1.1, demonstrating that in the present application, limiting the cooling rate in Step S1 to achieve rapid cooling can significantly shorten the time that Ce in the alloy ingot comes into contact with oxygen during the cooling process, which reduces the possibility of Ce oxidation and reduces the number of magnetic phases in the cerium-iron-boron that are oxidized and decomposed, thereby ensuring an enhancement in the intrinsic coercivity of the cerium-iron-boron.

The bending strengths of Example 3.1 at 25° C. and 300° C. are much higher than those of Example 1.1, while the remanence and intrinsic intrinsic coercivity show no significant changes. The bending strengths of Example 3.2 at 25° C. and 300° C. show no significant difference compared with Example 1.1, demonstrating that using sheet-shaped diffusion sources in the grain boundary diffusion of the cerium-iron-boron can achieve both enhanced mechanical properties and good diffusion effects.

Among Examples 1.1 and 4.1-4.3, Example 4.2 exhibits the highest remanence and intrinsic coercivity, and among Examples 1.1 and 4.4-4.6, Example 4.4 exhibits the highest remanence and intrinsic coercivity, demonstrating that in the diffusion heat treatment of the present application, controlling the first diffusion time to 1.8 hours and the second diffusion time to 4 hours can further promote grain boundary diffusion in the early stage of diffusion and bulk diffusion in the later stage, thereby significantly enhancing the magnetic properties of the cerium-iron-boron.

The bending strengths of Examples 5.1-5.2 at both 25° C. and 300° C. are higher than those of Example 1.1, and the remanence and intrinsic coercivity of Examples 5.1-5.2 are also higher than those of Example 1.1, demonstrating that performing sintering in two stages in the present application can fully discharge the organic matter, gas adsorbed on the particle surface, and gas remaining in the pores of the cerium-iron-boron blank. The two-stage sintering process improves the purity of the cerium-iron-boron blank and optimizes the mechanical properties of the cerium-iron-boron. Additionally, the two-stage sintering process can further control the growth of grains to produce more uniform and smaller grains, significantly reducing the number and growth rate of coarse grains, thereby enhancing the remanence and intrinsic coercivity of the cerium-iron-boron.

Among Examples 6.1-6.4, only the time of the first stage aging was varied. The data show that Examples 6.2 and 6.3 have higher bending strengths at both 25° C. and 300° C., as well as higher remanence and intrinsic coercivity than those of the other examples. Based on these results, the time of the second stage aging was further adjusted based on Example 6.2. It was found that Examples 6.7 and 6.8 exhibited higher bending strengths at 25° C. and 300° C., as well as higher remanence and intrinsic coercivity. Additionally, the time of the second stage aging of Examples 6.7 and 6.8 were validated based on Example 6.3, resulting in further improvements in the bending strengths at 25° C. and 300° C., remanence, and intrinsic coercivity of the cerium-iron-boron. These findings demonstrate that the present application controls the time for the first stage aging and the time for the second stage aging, within the time range, the number of intact cells inside the cerium-iron-boron is relatively large, and the regularity of the internal cell structure and the continuity of the cell wall phase are also high. At the same time, the possibility of large cells swallowing small cells occurring inside the cerium-iron-boron blank is low, and the cell structure has a strong pinning effect on the domain wall. The enhancement of pinning effect will simultaneously improve the magnetic properties, high-temperature resistance, and mechanical properties of the cerium-iron-boron.

Compared to Example 1.1, Comparative Example 1 exhibits a significant reduction in remanence and intrinsic coercivity, demonstrating that the grain boundary diffusion treatment method of the present application can effectively enhance the magnetic properties of the cerium-iron-boron.

Compared to Example 1.1, Comparative Examples 2 and 3 exhibit a significant reduction in remanence and intrinsic coercivity, demonstrating that the synergistic effect between Pr and Tb can be fully exerted, further enhancing the magnetocrystalline anisotropy field strength on the surface of cerium-iron-boron. The enrichment of Tb on the surface of the magnet compensates for the negative impact of coarse grains on magnetic performance, thereby further compensating for the deficiency of magnetic performance.

Compared to Example 1.1, Comparative Example 4 exhibits a reduction in bending strengths at both 25° C. and 300° C., demonstrating that the addition of Cu can compensate for the loss of mechanical strength of the cerium-iron-boron after adding Pr and Tb.

Comparative Example 5 exhibits a significant reduction in remanence and intrinsic coercivity, while Comparative Example 6 exhibits a substantial increase in the reduction rate of bending strength, compared to Example 1.1. These results demonstrate that by strictly controlling the addition of Ce, the present application can achieve an optimal balance of high-temperature resistance, remanence, and intrinsic coercivity of the cerium-iron-boron.

The above are the preferred embodiments of the present application, which are not intended to limit the protection scope of the present application. Therefore, all equivalent changes made according to the structure, shape and principle of the present application should be covered within the protection scope of the present application.

What is claimed is:

1. A method for preparing a sintered cerium-iron-boron, comprising the following steps:
melting and blending all raw materials, cooling to obtain an alloy ingot with an expression (Nd,M)ₐCe₂₋ₐFe₁₄B, and then subjecting the alloy ingot to crushing, powder milling, magnetically forming, isostatic pressing, sintering, solution treating, first stage aging, and second stage aging to obtain a product, wherein a=1.06-1.38, M is at least one selected from a group consisting of: Gd, Ti, and Zr, and the method further comprises a diffusion treatment of the product, comprising:
melting and blending a first phase alloy and a second phase alloy with a weight ratio of 1:(0.8-1.0) at a vacuum degree of −0.1 MPa-0.02 MPa and a temperature of 1300-1350° C., cooling, and obtaining a diffusion source after a post-treatment; an expression of the first phase alloy is PrₓCu₁₀₀₋ₓ, wherein x=68-72, and an expression of the second phase alloy is Pr_{y}Tb₁₀Cu_{90-y}, wherein y=58-62; then, coating the diffusion source on a surface of the product, performing a first diffusion for 1.5-2 hours under a vacuum degree of 4.8×10⁻³-5.2×10⁻³ Pa and a temperature of 850-900° C., and performing a second diffusion for 3-6 hours at a temperature of 980-1080° C., then cooling a resulting system to a temperature of 480-500° C., annealing for 1.5-2.5 hours, and finally cooling to room temperature to obtain the sintered cerium-iron-boron.

2. The method for preparing a sintered cerium-iron-boron according to claim 1, wherein the post-treatment comprises: cutting a cooled mixture to obtain sheet-shaped diffusion sources.

3. The method for preparing a sintered cerium-iron-boron according to claim 1, wherein a time of the first diffusion is 1.8 hours, and a time of the second diffusion is 4 hours.

4. The method for preparing a sintered cerium-iron-boron according to claim 1, wherein in the expression of the alloy ingot, a=1.25-1.35.

5. The method for preparing a sintered cerium-iron-boron according to claim 1, wherein after melting and blending all the raw materials, cooling is performed at a rate of 40-80° C./s to obtain the alloy ingot.

6. The method for preparing a sintered cerium-iron-boron according to claim 1, wherein the sintering is performed in two stages, comprising:
holding a material obtained after the isostatic pressing at a temperature of 800-850° C. for 1-1.5 hours, then heating the temperature up to 1050-1100° C. and holding for 2-2.5 hours, followed by the solution treating.

7. The method for preparing a sintered cerium-iron-boron according to claim 1, wherein a time of the first stage aging is 3-4 hours.

8. The method for preparing a sintered cerium-iron-boron according to claim 1, wherein a time of the second stage aging is 22-23 hours.

9. A sintered cerium-iron-boron prepared by the method for preparing a sintered cerium-iron-boron according to claim 1.
